(19) United States
(12) Patent Application Publication
(10) Pub. No.: US 2008/0030147 A1
(43) Pub. Date: Feb. 7, 2008

(54) Backlight driving circuit with capacitive discharging current path and liquid crystal display with same

(75) Inventors: Jian-Hui Lu, Shenzhen (CN); He-Kang Zhou, Shenzhen (CN); Tong Zhou, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/890,377

(22) Filed: Aug. 6, 2007

(30) Foreign Application Priority Data
Aug. 4, 2006 (TW) 95128628

(51) Int. Cl. H05B 41/00

(52) U.S. Cl. 315/282

(57) ABSTRACT

An exemplary backlight driving circuit (20) includes a first pulse generator (230), a second pulse generator (240), a transformer (250) having a primary winding (251), a first transistor (210), a second transistor (220), and a first capacitor (290). The first transistor is a P-MOSFET. The first transistor includes a gate electrode (211) connected to the first pulse generator, and a drain electrode (213) connected to a first terminal (252) of the primary winding. The second transistor is an N-MOSFET. The second transistor includes a gate electrode (221) connected to the second pulse generator, a source electrode (222) connected to ground, and a drain electrode (223) connected to the first terminal of the primary winding. The first capacitor includes one terminal connected to a second terminal of the primary winding.

### FIELD OF THE INVENTION

The present invention relates to a backlight driving circuit that includes a capacitive discharging current path, and a liquid crystal display (LCD) including the backlight driving circuit.

### BACKGROUND

LCDs are commonly used as displays for compact electronic apparatuses, because they not only provide good quality images but are also very thin. The liquid crystal in an LCD does not emit any light itself. The liquid crystal has to be lit by a light source so as to clearly and sharply display text and images. Thus, a backlight module and a backlight driving circuit for driving the backlight module are generally needed for an LCD.

Referring to FIG. 3, a typical backlight driving circuit 10 includes an 18-volt power supply 160, a first pulse generator 130, a second pulse generator 140, a first capacitor 190, a second capacitor 170, a third capacitor 180, a first transistor 110, a second transistor 120, and a transformer 150 having a primary winding 151.

The first transistor 110 is a P-channel enhancement mode metal-oxide-semiconductor field-effect transistor (P-MOSFET), which includes a gate electrode 111 connected to the first pulse generator 130, a source electrode 112 connected to the power supply 160, and a drain electrode 113 connected to a first terminal 152 of the primary winding 151 of the transformer 150.

The second transistor 120 is an N-channel enhancement mode metal-oxide-semiconductor field-effect transistor (N-MOSFET), which includes a gate electrode 121 connected to the second pulse generator 140, a source electrode 122 connected to ground, and a drain electrode 123 connected to the first terminal 152 of the primary winding 151 of the transformer 150.

The first capacitor 190 includes a terminal (not labeled) connected to ground, and another terminal (not labeled) connected to a second terminal 153 of the primary winding 151 of the transformer 150. The second capacitor 170 includes a terminal (not labeled) connected to ground, and another terminal (not labeled) connected to the power supply 160 for filtering low frequency interferences from the power supply 160. The third capacitor 180 includes a terminal (not labeled) connected to ground, and another terminal (not labeled) connected to the power supply 160 for filtering high frequency interferences from the power supply 160.

In operation of the backlight driving circuit 10, when pulse signals from the first and second pulse generators 130, 140 are both low level signals, the first transistor 110 is switched on, and the second transistor 120 is switched off. The power supply 160, the first transistor 110, the primary winding 151 of the transformer 150, and the first capacitor 190 cooperatively form a charging current path. The power supply 160 provides primary energy stored in the transformer 150 to increase a primary current of the transformer 150, and charges the first capacitor 190. When the first capacitor 190 and the primary winding 151 of the transformer 150 proceed to resonate in series, the primary current of the transformer 150 reaches a maximal value. That is, a primary energy storage of the transformer 150 reaches a saturated state. Then the transformer 150 proceeds to release the primary energy stored therein, and begins to charge the first capacitor 190. Thus, the primary current of the transformer 150 progressively decreases. When the first capacitor 190 is charged to 18V (18 volts), the primary energy stored in the transformer 150 is completely released, and the primary current of the transformer 150 is equal to 0.

When the pulse signals from the first and second pulse generators 130, 140 are both high level signals, the first transistor 110 is switched off, and the second transistor 120 is switched on. The first capacitor 190, the primary winding 151 of the transformer 150, and the second transistor 120 cooperatively form a discharging current path. The first capacitor 190 begins to discharge, the transformer 150 begins to store primary energy therein, and the primary current of the transformer 150 progressively increases. When the first capacitor 190 and the primary winding 151 of the transformer 150 proceed to resonate in series, the primary current of the transformer 150 reaches the maximal value. That is, the primary energy storage of the transformer 150 reaches the saturated state. Then the transformer 150 begins to release the primary energy stored therein, and the first capacitor 190 continues to discharge.

In the charging current path formed by the power supply 160, the first transistor 110, the primary winding 151 of the transformer 150, and the first capacitor 190, the first capacitor 190 is easily charged to 18V because the current passing therethrough is a high current. Moreover, the first transistor 110 is a P-MOSFET having a large essential resistance, which is typically at least 0.1Ω (ohms). Therefore the first transistor 110 has high power consumption, and correspondingly dissipates a large amount of the power consumed in the form of heat energy. Thus the first transistor 110 has a high working temperature, which is liable to affect its performance. This in turn means the reliability of the backlight driving circuit 10 may be impaired.

What is needed, therefore, is a backlight driving circuit that can overcome the above-described deficiencies. What is also need is an LCD including the backlight driving circuit.

### SUMMARY

In an exemplary embodiment, a backlight driving circuit includes a first pulse generator, a second pulse generator, a transformer having a primary winding, a first transistor, a second transistor, and a first capacitor. The first transistor is a P-channel metal-oxide-semiconductor field-effect transistor. The first transistor includes a gate electrode connected to the first pulse generator, and a drain electrode connected to a first terminal of the primary winding of the transformer. The second transistor is an N-channel metal-oxide-semiconductor field-effect transistor. The second transistor includes a gate electrode connected to the second pulse generator, a source electrode connected to ground, and a drain electrode connected to the first terminal of the primary winding of the transformer. The first capacitor includes one terminal connected to a second terminal of the primary winding of the transformer.

Other novel features, advantages and aspects will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is a block diagram of an LCD according an exemplary embodiment of the present invention, the LCD including a backlight module, a backlight driving circuit for driving the backlight module, and a liquid crystal panel.

FIG. 2 is a circuit diagram of the backlight driving circuit of FIG. 1.

FIG. 3 is a circuit diagram of a conventional backlight driving circuit.

### DETAILED DESCRIPTION OF PREFERRED EMBODIMENTS

Reference will now be made to the drawings to describe preferred and exemplary embodiments in detail.

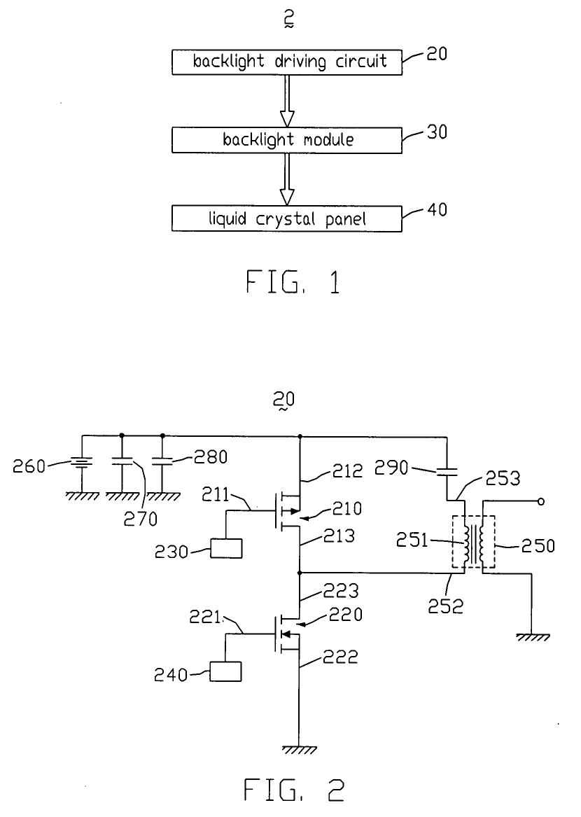

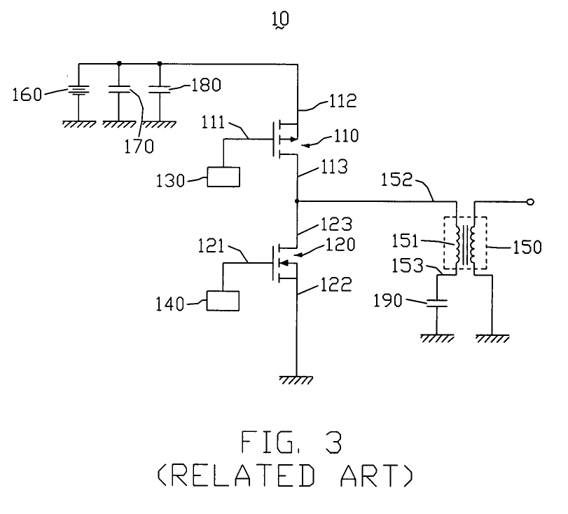

Referring to FIG. 1, an LCD 2 according to an exemplary embodiment of the present invention includes a liquid crystal panel 40, a backlight module 30 located adjacent to the liquid crystal panel 40 for providing a planar light source for the liquid crystal panel 40, and a backlight driving circuit 20 for driving the backlight module 30.

Referring also to FIG. 2, the backlight driving circuit 20 includes a power supply 260, a first pulse generator 230, a second pulse generator 240, a first capacitor 290, a second capacitor 270, a third capacitor 280, a first transistor 210, a second transistor 220, and a transformer 250 having a primary winding 251.

The first transistor 210 is typically a P-channel enhancement mode metal-oxide-semiconductor field-effect transistor, which includes a gate electrode 211 connected to the first pulse generator 230, a source electrode 212 connected to the power supply 260, and a drain electrode 213 connected to a first terminal 252 of the primary winding 251 of the transformer 250.

The second transistor 220 is typically an N-channel enhancement mode metal-oxide-semiconductor field-effect transistor, which includes a gate electrode 221 connected to the second pulse generator 240, a source electrode 222 connected to ground, and a drain electrode 223 connected to the first terminal 252 of the primary winding 251 of the transformer 250.

The first capacitor 290 includes a terminal (not labeled) connected to the power supply 260, and another terminal (not labeled) connected to a second terminal 253 of the primary winding 251 of the transformer 250.

The second capacitor 270 includes a terminal (not labeled) connected to ground, and another terminal (not labeled) connected to the power supply 260 for filtering low frequency interferences from the power supply 260. In the exemplary embodiment, the second capacitor 270 is an electrolytic capacitor, and a capacitance of the electrolytic capacitor is 220 μF (microfarads).

The third capacitor 280 includes a terminal (not labeled) connected to ground, and another terminal (not labeled) connected to the power supply 260 for filtering high frequency interferences from the power supply 260. In the exemplary embodiment, the third capacitor 280 is a multilayer ceramic capacitor (MLCC).

In the exemplary embodiment, the power supply 260 is an 18V power supply. An amplitude of the first pulse generator 230 is 18V, a working frequency of the first pulse generator 230 is 50 KHz, and a duty ratio of the first pulse generator 230 is 0.65. An amplitude of the second pulse generator 240 is 5V, a working frequency of the second pulse generator 240 is 50 KHz, and a duty ratio of the second pulse generator 240 is 0.35. The first and second transistors 210, 220 are typically AP4511GH transistors. The transformer 250 is typically an EEL19 transformer.

In operation of the backlight driving circuit 20, when pulse signals from the first and second pulse generators 230, 240 are both high level signals, the first transistor 210 is switched off, and the second transistor 220 is switched on. The power supply 260, the first capacitor 290, the primary winding 251 of the transformer 250, and the second transistor 220 cooperatively form a charging current path. The power supply 260 provides primary energy storage stored in the transformer 250 to increase a primary current of the transformer 250, and charges the first capacitor 290. When the first capacitor 290 and the primary winding 251 of the transformer 250 proceed to resonate in series, the primary current of the transformer 250 reaches a maximal value. That is, a primary energy storage of the transformer 250 reaches a saturated state. Then the transformer 250 continues to release the primary energy stored therein, the power supply 260 continues to charge the first capacitor 290, and the primary current of the transformer 250 progressively decreases. When the first capacitor 290 is charged to 18V, the stored primary energy of the transformer 250 is completely released, and the primary current of the transformer 250 is equal to 0.

When the pulse signals from the first and second pulse generators 230, 240 are both low level signals, the first transistor 210 is switched on, and the second transistor 220 is switched off. The first capacitor 290, the primary winding 251 of the transformer 250, and the first transistor 210 cooperatively form a discharging current path. The first capacitor 290 begins to discharge, the transformer 250 begins to store primary energy therein, and the primary current of the transformer 250 progressively increases. When the first capacitor 290 and the primary winding 251 of the transformer 250 proceed to resonate in series, the primary current of the transformer 250 reaches the maximal value. That is, the primary energy storage of the transformer 250 reaches the saturated state. Then the transformer 250 begins to release the primary energy stored therein, and the first capacitor 290 continues to discharge.

In summary, the backlight driving circuit 20 includes the discharging current path formed by the first capacitor 290, the primary winding 251 of the transformer 250, and the first transistor 210. Because the first capacitor 290 has a characteristic whereby it generally cannot be discharged completely, the current passing through the first transistor 210 is relatively low. Therefore the first transistor 210 has low power consumption, and correspondingly dissipates a low amount of the power consumed in the form of heat energy. Thus the first transistor 210 can reliably operate with a low working temperature. Moreover, the backlight driving circuit 20 further includes the charging current path formed by the power supply 260, the primary winding 251 of the transformer 250, and the second transistor 220. Because the first capacitor 290 has a characteristic whereby it generally can be charged completely, the current passing through the second transistor 220 is relatively high. However, the second transistor 220 is an N-MOSFET having relatively low essential resistance, which is typically about 0.01Ω. Therefore the second transistor 220 has low power consumption, and correspondingly dissipates a low amount of the power consumed in the form of heat energy. Thus the second transistor 220 can reliably operate with a low working temperature. These advantages mean that the reliability of the backlight driving circuit 20 and the LCD 2 are improved.

In an alternative embodiment, the first transistor 210 can be a P-channel depletion mode metal-oxide-semiconductor field-effect transistor. In another alternative embodiment, the second transistor 220 can be an N-channel depletion mode metal-oxide-semiconductor field-effect transistor.

It is believed that the present embodiments and their advantages will be understood from the foregoing description, and it will be apparent that various changes may be made thereto without departing from the spirit or scope of the invention or sacrificing all of its material advantages, the examples hereinbefore described merely being preferred or exemplary embodiments of the invention.

What is claimed is:

1. A backlight driving circuit comprising:
a first pulse generator;
a second pulse generator;
a transformer comprising a primary winding;
a first transistor, the first transistor being a P-channel metal-oxide-semiconductor field-effect transistor, and comprising a gate electrode connected to the first pulse generator, and a drain electrode connected to a first terminal of the primary winding of the transformer;
a second transistor, the second transistor being an N-channel metal-oxide-semiconductor field-effect transistor, and comprising a gate electrode connected to the second pulse generator, a source electrode connected to ground, and a drain electrode connected to the first terminal of the primary winding of the transformer; and
a first capacitor, the first capacitor comprising one terminal connected to a second terminal of the primary winding of the transformer.

2. The backlight driving circuit as claimed in claim 1, wherein an amplitude of the first pulse generator is about 18V, a working frequency of the first pulse generator is about 50 KHz, and a duty ratio of the first pulse generator is about 0.65.

3. The backlight driving circuit as claimed in claim 1, wherein an amplitude of the second pulse generator is about 5V, a working frequency of the second pulse generator is about 50 KHz, and a duty ratio of the second pulse generator is about 0.35.

4. The backlight driving circuit as claimed in claim 1, wherein the transformer is an ELL19 transformer.

5. The backlight driving circuit as claimed in claim 1, wherein the first and second transistors are AP4511GH transistors.

6. The backlight driving circuit as claimed in claim 1, further comprising a power supply, wherein the power supply is connected to a source electrode of the first transistor and another terminal of the first capacitor.

7. The backlight driving circuit as claimed in claim 6, wherein the power supply is an 18-volt power supply.

8. The backlight driving circuit as claimed in claim 6, further comprising a second capacitor, wherein the second capacitor comprises one terminal connected to ground, and another terminal connected to the power supply.

9. The backlight driving circuit as claimed in claim 8, wherein the second capacitor is an electrolytic capacitor.

10. The backlight driving circuit as claimed in claim 8, wherein a capacitance of the second capacitor is about 220 μF.

11. The backlight driving circuit as claimed in claim 8, further comprising a third capacitor, wherein the third capacitor comprises one terminal connected to ground, and another terminal connected to the power supply.

12. The backlight driving circuit as claimed in claim 11, wherein the third capacitor is a multilayer ceramic capacitor.

13. The backlight driving circuit as claimed in claim 1, wherein a capacitance of the third capacitor is 0.01 μF.

14. The backlight driving circuit as claimed in claim 1, wherein the first transistor is a P-channel enhancement mode metal-oxide-semiconductor field-effect transistor, or a P-channel depletion mode metal-oxide-semiconductor field-effect transistor.

15. The backlight driving circuit as claimed in claim 1, wherein the second transistor is an N-channel enhancement mode metal-oxide-semiconductor field-effect transistor, or N-channel depletion mode metal-oxide-semiconductor field-effect transistor.

16. A liquid crystal display comprising:
a liquid crystal panel;
a backlight module adjacent to the liquid crystal panel; and
a backlight driving circuit configured for driving the backlight module, the backlight driving circuit comprising:
a first pulse generator;
a second pulse generator;
a transformer comprising a primary winding;
a first transistor, the first transistor being a P-channel metal-oxide-semiconductor field-effect transistor, and comprising a gate electrode connected to the first pulse generator, and a drain electrode connected to a first terminal of the primary winding of the transformer;
a second transistor, the second transistor being an N-channel metal-oxide-semiconductor field-effect transistor, and comprising a gate electrode connected to the second pulse generator, a source electrode connected to ground, and a drain electrode connected to the first terminal of the primary winding of the transformer; and
a first capacitor, the first capacitor comprising one terminal connected to a second terminal of the primary winding of the transformer.

17. The liquid crystal display as claimed in claim 16, further comprising a power supply, wherein the power supply is connected to a source electrode of the first transistor and another terminal of the first capacitor.

18. A backlight driving circuit comprising:
a first transistor, the first transistor being a P-channel metal-oxide-semiconductor field-effect transistor;
a first pulse generator connected to the first transistor;
a transformer having a primary winding, the primary winding comprising
a first terminal connected to the first transistor; and
a second terminal;
a second transistor connected to the first terminal of the primary winding, the second transistor being an N-channel metal-oxide-semiconductor field-effect transistor;
a second pulse generator connected to the second transistor; and
a first capacitor connected to the second terminal of the primary winding; wherein the first capacitor, the primary winding of the transformer, and the second transistor cooperatively form a charging current path when pulse signals from the first and second pulse generators are high level signals; and
the first capacitor, the primary winding of the transformer, and the first transistor cooperatively form a discharging current path when the pulse signals from the first and second pulse generators are low level signals.

19. The backlight driving circuit as claimed in claim 18, wherein the first transistor is a P-channel enhancement mode metal-oxide-semiconductor field-effect transistor.

20. The backlight driving circuit as claimed in claim 18, wherein the second transistor is an N-channel enhancement mode metal-oxide-semiconductor field-effect transistor.
